(19) United States
(12) Patent Application Publication
(10) Pub. No.: US 2018/0120890 A1
(43) Pub. Date: May 3, 2018

(54) SIGNAL FILTERING

(71) Applicant: HEWLETT PACKARD ENTERPRISE DEVELOPMENT LP, Houston, TX (US)

(72) Inventor: Benjamin Thomas Gaide, Houston, TX (US)

(21) Appl. No.: 15/336,480

(22) Filed: Oct. 27, 2016

(51) Int. Cl. G06F 1/08; G06F 9/44; G06F 13/42; G06F 9/445

(52) U.S. Cl. CPC G06F 1/08; G06F 8/65; G06F 13/4291; G06F 9/4411

(57) ABSTRACT

In various examples, a system comprises a computing device comprising a transmitter coupled to a high frequency serial communication interface. The transmitter may transmit a signal to another computing device via the high frequency communication interface. The system comprises a processor coupled to the high frequency serial communication interface. The processor may: generate a lower frequency protocol signal, a value of the lower frequency protocol signal to cause the another computing device to perform a management operation, and transmit the lower frequency protocol signal on the high frequency serial communication interface.

### BACKGROUND

A computing device may communicate via a high frequency serial interface. The high frequency serial interface allows the computing device to communicate with peripherals and/or other computing devices

### BRIEF DESCRIPTION OF THE DRAWINGS

Certain examples are described in the following detailed description and in reference to the drawings, in which:

FIG. 1 is a conceptual diagram of an example system for signal filtering;

FIG. 2 is a conceptual diagram of another example system for signal filtering;

FIG. 3 is another conceptual diagram of an example system for signal filtering;

FIG. 4 is a flowchart of an example method for performing signal filtering;

FIG. 5 is a flowchart of another example method for performing signal filtering;

FIG. 6 is a block diagram of an example system for performing signal filtering; and

FIG. 7 is a block diagram of another example system for performing signal filtering.

### DETAILED DESCRIPTION

Various computing devices, such as direct attached storage (DAS) appliances may connect to a server via a high frequency serial communication interface, such as a Serial Attached SCSI (SAS) or PCI-Express (PCIE) interface (via a SAS cable). These DAS appliances may lack management capabilities as the appliances may be attached to a server solely through the high frequency serial interface. Because the appliances lack a management interface, the appliances may not be powered-up from stand-by, cannot recover from bad firmware flashes, or perform other management operations.

The techniques of this disclosure provide management capabilities for computing devices that are connected via high a high frequency serial interface, but that lack a dedicated management interface. More particularly, the techniques of this disclosure describe encoding relatively lower frequency (in the kilohertz frequency range) serial data within a signal of a high frequency (in the gigahertz range) communication interface that is used to connect a computing device (e.g. a server) with an other computing device (e.g. a storage appliance). The lower frequency serial data is encoded such that it does not interfere with the encoding of the high frequency communication interface. A circuit comprises capacitors that ensure that low frequency serial data is transmitted without generating edges and can be read without corrupting the high frequency signal.

A microcontroller generates a lower frequency serial protocol signal and adds the lower frequency serial to a high frequency serial protocol signal generated by a host bus adapter (HBA) of a server. The combined signal is transmitted to an appliance for processing. The appliance receives the combined high frequency serial data, and a capacitor network filters the high- and low frequency signals.

A microcontroller on the appliance processes the low frequency data, and may perform an action in response to receiving an indication in the low frequency signal. As examples, the microcontroller may receive a signal to cause the appliance to power-up from a powered down state, receive a signal to cause the appliance to select a particular communication protocol for the high frequency interface. The appliance may also receive a signal to cause the appliance to perform a firmware update or recover from a firmware failure.

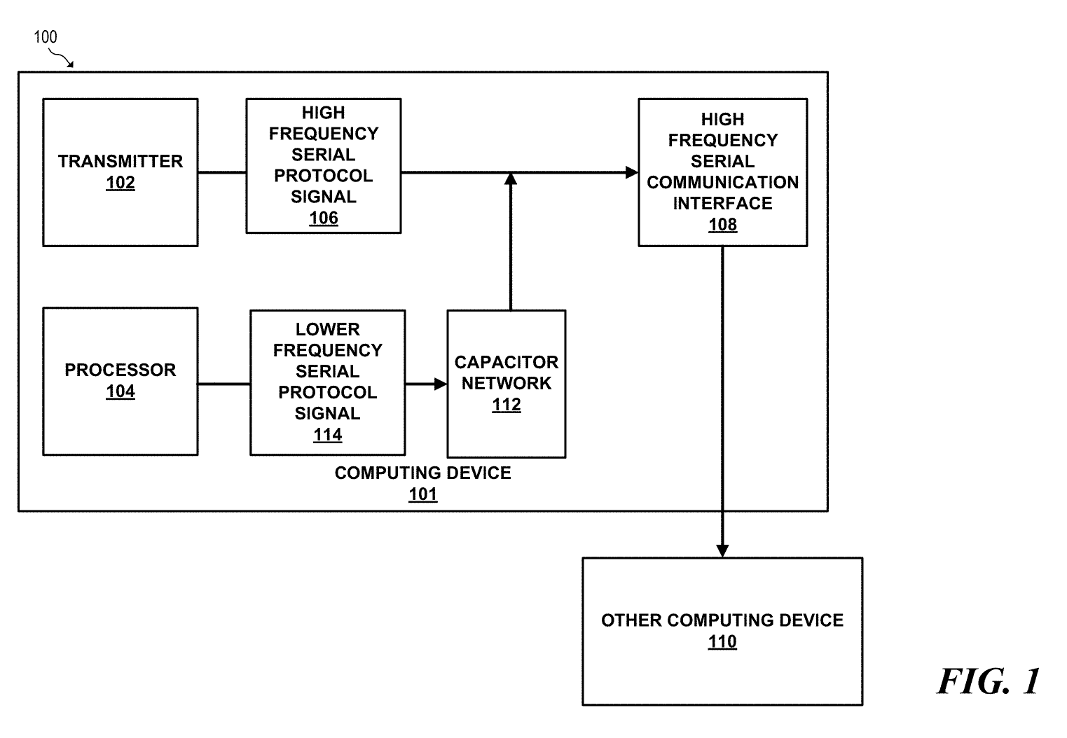

FIG. 1 is a conceptual of an example system for performing signal filtering. System 100 comprises a computing device 101 and other computing device 110. Computing device 101 may comprise a server in various examples. Other computing device 110 may comprise a storage appliance in various examples.

Computing device 101 comprises a processor 104, and a transmitter 102. Processor 104 may comprise a microcontroller in various examples. Transmitter 102 may comprise a transmitter of a host bus adapter (HBA).

Transmitter 102 and processor 104 are coupled to high frequency serial communication interface 108. High frequency serial communication interface 108 may comprise an interface such as serial attached SCSI (SAS) or PCI Express (PCIE) in various examples. Either SAS or external PCIE signal data may be transmitted using a same connector associated with high frequency serial communication interface 108, such a SAS connector.

Other computing device 110 is coupled to computing device 101 via high frequency serial communication interface 108. In some examples, other computing device 101 may comprise a first processor for receiving data from high frequency serial communication interface 108, and a second processor for receiving data from lower frequency serial protocol signal 114.

Other computing device 110 may transmit data to one or more storage devices coupled to other computing device 110. Other computing device 110 may not have a management interface and/or lack the capability to perform management operations, such as firmware updates, power-up from stand-by, resolution of host bus adapter conflicts, or selection of a communications protocol for high frequency serial communication interface 108.

The second processor of other computing device 110 may perform the management operations as described herein. For example, if the first processor dedicated to receiving high frequency serial protocol signal 106 experiences a firmware error, or a bad flash, the first processor may become inoperable. The techniques of this disclosure add the second processor, which may still operate in the event of a failure of the first processor. In some examples, the second processor may allow computing device 101 to recover from a bad flash or from a firmware error, e.g. by restarting the first processor or performing a re-flash of the firmware.

In other examples, an operator may wish to power other computing device 110 down or put other computing device 110 into standby mode. However, other computing device 110 may lack the capability to be powered-up. In such cases, the processor that receives the lower frequency serial communication protocol may power up other computing device in response to an indication from computing device 101.

In still other examples, high frequency serial communication interface 108 may support different high speed serial protocols using the same cabling. For example, high frequency serial communication interface 108 may support transmission of both PCIe and SAS data. However, the communication protocol may not be negotiated on the fly. In various examples, the processor that receives lower frequency serial protocol may select the communication protocol be used over high frequency serial communication interface 108 in response to receiving an indication from computing device 101.

Transmitter 102 may generate a high frequency signal 106. High frequency signal 106 may be a SAS or PCIe signal, or the like. Transmitter 102 may generate a high frequency signal 106 that is in the hundreds of megahertz to multiple tens of gigahertz frequency range (e.g. 12 gigahertz).

Processor 104 may generate a lower frequency serial protocol signal 114. Lower frequency serial protocol signal 114 may be in the kilohertz frequency range. As examples, the lower frequency protocol signal may comprise an interface such as RS-232, or another serial communication protocol.

Capacitor network 112 may smooth the edges of lower frequency serial protocol signal 114. Smoothing is a process by which capacitor network 112 may increase the time for edge transitions. Capacitor network 112 may smooth lower frequency serial protocol signal 114 such that lower frequency serial protocol signal 114 may be combined with high frequency signal 106 without causing bit errors in capacitor network 112. As an example, capacitor network 112 may smooth lower frequency serial protocol signal 114 such that edge transitions of lower frequency serial protocol signal 114 take at least 10 clock cycles as measured by a transceiver of high frequency serial communication interface 108.

Other computing device 110 may receive the high frequency and low frequency signals via high frequency serial communication interface 108. A capacitor network (not pictured) separates the high frequency and low frequency signals. A receiver for the high-frequency signal handles the high frequency signal 106. The receiver may be coupled to the first processor (not pictured). A second processor (e.g. a microcontroller) of other computing device 110 processes lower frequency serial protocol signal 114 to determine a management operation to perform on other computing device 110.

The value of the lower frequency signal may cause other computing device 110 to, responsive to receiving the signal to perform a management operation. As examples, a management operation may comprise: performing a firmware update of a component of other computing device 110, selecting a communications protocol for high frequency serial communication interface 108 (e.g. selecting between PCIE or SAS protocols) or resolving a conflict between a plurality of hosts associated with high frequency serial communication interface 108.

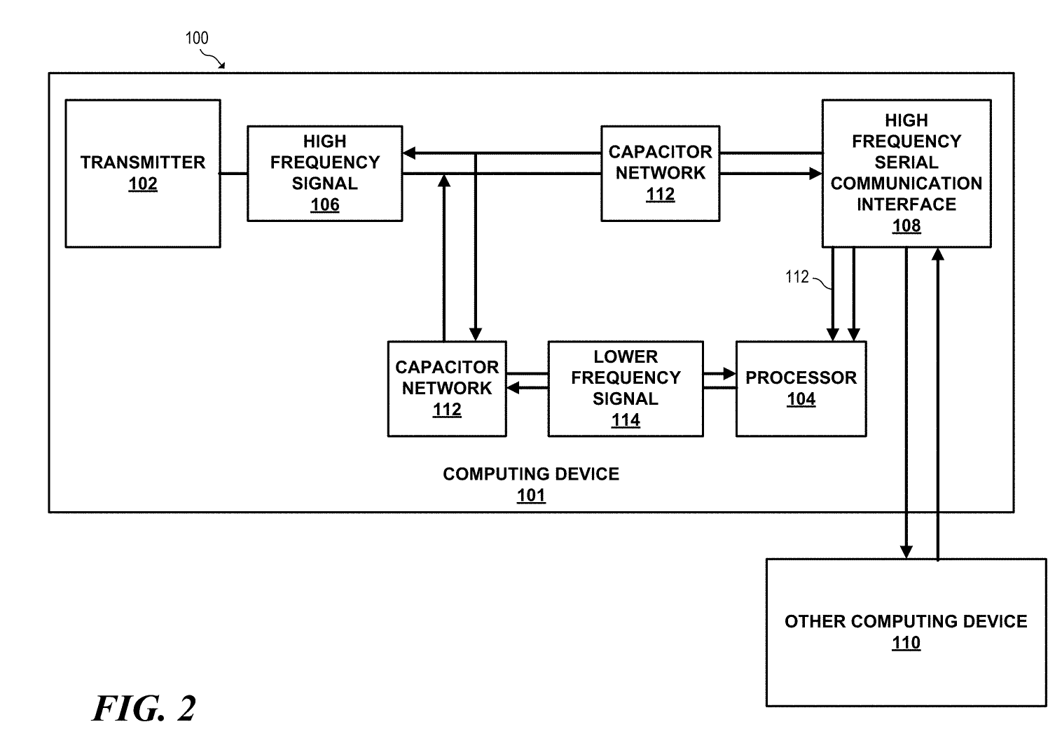

FIG. 2 is a conceptual diagram of another example system for signal filtering. FIG. 2 illustrates a system 200. System 200 may be similar to system 100 of FIG. 1. System 200 comprises computing device 101 and other computing device 110.

In the example of FIG. 2, processor 104 is coupled to a differential pair 112 of high frequency serial communication interface 108. When generating lower frequency signal 114, processor 104 may determine a ground value based on a voltage value of differential pair 112. Other communication links of high frequency serial communication interface 108 may also comprise differential pairs even though they are illustrated as single wires.

In the example of FIG. 2, other computing device 110 and computing device 101 are coupled by a bidirectional link of high frequency serial communication interface 108. In various examples, other computing device 110 may transmit data to computing device 101 via high frequency serial communication interface 108.

Capacitor network 112 may filter the received signal into high frequency signal 106 and lower frequency signal 114. Processor 104 may receive the filtered lower frequency signal 114 and may read the signal. To read the signal, processor 104 may cause a capacitor of capacitor network 112 to charge. Responsive to charging the capacitor, processor 104 may read a value of the lower frequency signal 114. Processor 104 may charge the capacitor to ensure that reading the lower frequency signal does not cause excessive current drain when reading lower frequency signal 114. Other computing device 110 may also comprise a capacitor network similar to capacitor network 112.

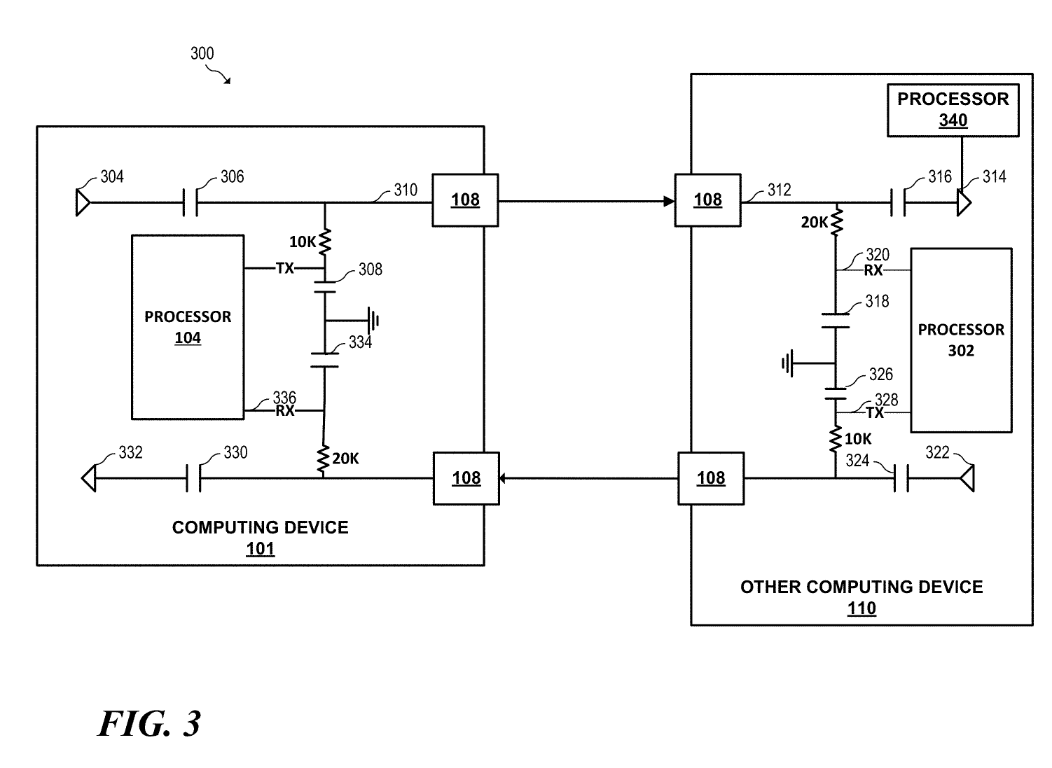

FIG. 3 is another conceptual diagram of a system for performing signal filtering. FIG. 3 illustrates a system 300. System 300 comprises a computing device 101 and other computing device 110. System 300 illustrates an example circuit-level diagram for performing signal filtering.

In the example of FIG. 3, computing device 101 comprises a high-frequency transmitter 304. High-frequency transmitter 304 generates a high frequency serial protocol signal on wire 310 for transmission over high frequency serial communication interface 108. Wire 310 may comprise a differential pair in various examples. High-frequency transmitter 304 is coupled to an AC coupling capacitor 306 to remove DC bias.

During transmission, processor 104 may generate a low-frequency serial protocol signal (e.g. lower frequency signal 114 of FIGS. 1 and 2) via the TX wire that is coupled to a 10K resistor and smoothing capacitor 308. Smoothing capacitor 308 may smooth the edges of the lower frequency serial protocol signal to ensure that the edge transitions of the lower frequency signal do not interfere with or cause corruption of the high frequency signal.

Other computing device 110 is coupled to high frequency serial communication interface 108 and receives the combined signal on wire 312. Capacitor 316 may comprise an AC coupling capacitor that removes any DC bias from the high frequency serial protocol signal. Receiver 314 receives the filtered high-frequency serial protocol signal.

Capacitor 318 charges before processor 302 read the low-frequency serial protocol signal via RX wire 320. Capacitor 318 charges to reduce the amount of current drain that processor 302 induces. Responsive to charging capacitor 318, processor 302 may read the value of the low-frequency serial protocol signal and perform a management operation.

In various examples, to perform the management operation, processor 302 may power-up or power down other computing device 110. Processor 302 may cause other computing device 110 to power down to save power, in the event of a hardware failure, or in response to an environmental condition, e.g. facility air conditioning or power failure. In some examples, processor 302 may cause other computing device 110 to power down in response to a network security incident.

In some examples, processor 110 may grant access to diagnostic or control capabilities of process 302 when high-speed communication between computing device 101 and other computing device 110 is not established.

In some examples, processor 302 may generate a low-frequency serial protocol signal to transmit to computing device 101. Processor 302 may generate the lower-frequency serial protocol signal and transmit the signal on TX wire 328. Capacitor 326 may smooth the edges of the lower-frequency serial protocol signal. Transmitter 322 may generate a high-frequency serial protocol signal, and AC coupling capacitor 324 may remove DC offset from the signal. The lower-frequency serial protocol signal is added to the high frequency serial protocol signal responsive to capacitor 326 generating the lower-frequency serial protocol signal, and other computing device 110 transmits the combined signal to computing device 101 via high frequency serial communication interface 108.

In some examples, processor 302 may generate a lower-frequency serial protocol signal to transmit to computing device 101 in the event of a condition that processor 302 detects. As an example, processor 302 may detect that a hardware module comprising a processor for high frequency serial communication interface 108 is not fully inserted, a main power failure (e.g. a power supply unit failure, fuse failure, board fault or regulator failure), a thermal event, or damage to transmitter 322 or receiver 314.

As some other examples, processor 302 may detect corrupt firmware, a failed flash, or a firmware crash of a processor of other computing device 110 that is couple with high frequency serial communication interface 108. In response to detecting any of these conditions, processor 302 may generate and transmits a lower-frequency serial protocol signal to computing device 101.

Computing device 101 receives the signal transmitted by other computing device 110. AC coupling capacitor 330 removes DC offset from the received signal, and high-frequency receiver 332 receives the high-frequency component of the signal.

Capacitor 334 charges responsive to receiving a lower frequency serial protocol signal to read. Responsive to charging capacitor 334, processor 104 reads a value of the lower-frequency serial protocol signal via RX wire 336. Responsive to reading the value of the lower-frequency serial protocol signal, processor 104 may perform a management operation.

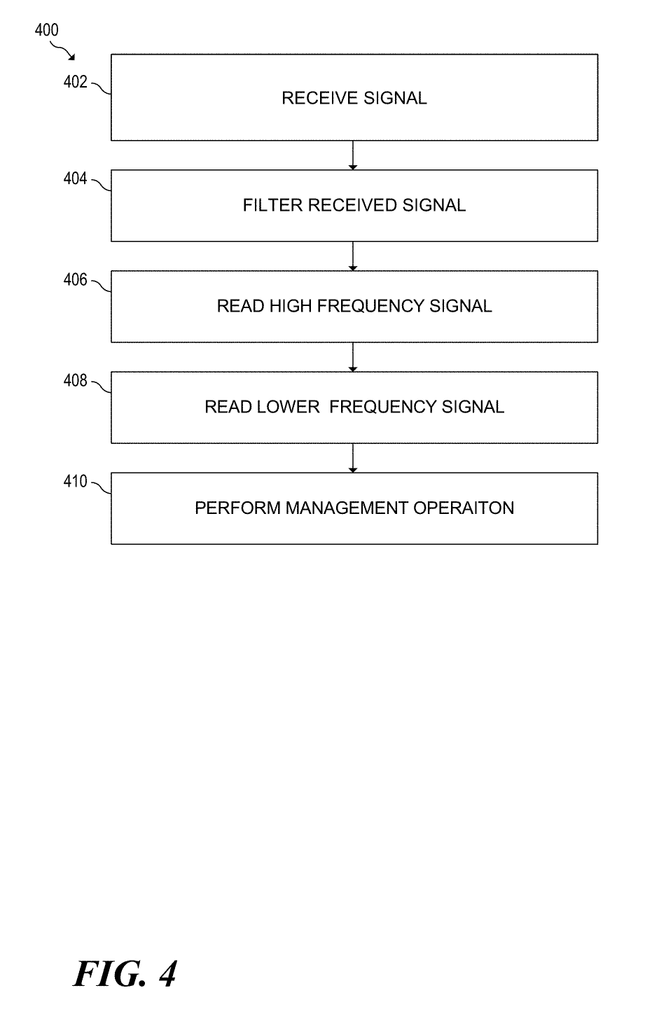

FIG. 4 is a flowchart of an example method for performing signal filtering. Method 400 may be described below as being executed or performed by a system, for example, system 100, 200, or 300 as described with respect to FIGS. 1, 2, and/or 3. Other suitable systems and/or computing devices may be used as well.

Method 400 may be implemented in the form of executable instructions stored on at least one machine-readable (e.g. a non-transitory) storage medium of the system and executed by at least one processor of the system (e.g. processor 104 or 302). Alternatively or in addition, method 400 may be implemented in the form of electronic circuitry (e.g., hardware). In alternate examples of the present disclosure, one or more blocks of method 400 may be executed substantially concurrently or in a different order than shown in FIG. 4. In alternate examples of the present disclosure, method 400 may include more or fewer blocks than are shown in FIG. 4. In some examples, one or more of the blocks of method 400 may, at certain times, be ongoing and/or may repeat.

Method 400 may start at block 402 at which point a processor, such as processor 302 may receive via a communication interface of a computing device (e.g. high frequency serial communication interface 108).

At block 404, capacitors 316, 320 may filter the received signal into a high frequency serial protocol signal and a lower frequency serial protocol signal. In various examples, the high frequency serial communication protocol may comprise at least one of: a SAS or a PCIe protocol.

At block 406, processor 340 may read a value of the high frequency serial protocol signal. At block 408, processor 302 may read a value of the lower frequency protocol signal. In some examples the lower-frequency protocol may comprise an RS-232 protocol.

At block 410, responsive to reading the value of the lower frequency serial protocol signal, processor 302 may perform a management operation on the computing device. In various examples, to perform the management operation, processor 302 may perform at least one of: performing a firmware update of a component of the computing device, powering up the computing device, selecting a communications protocol for the communication interface, or resolving a conflict between a plurality of hosts of the communication interface.

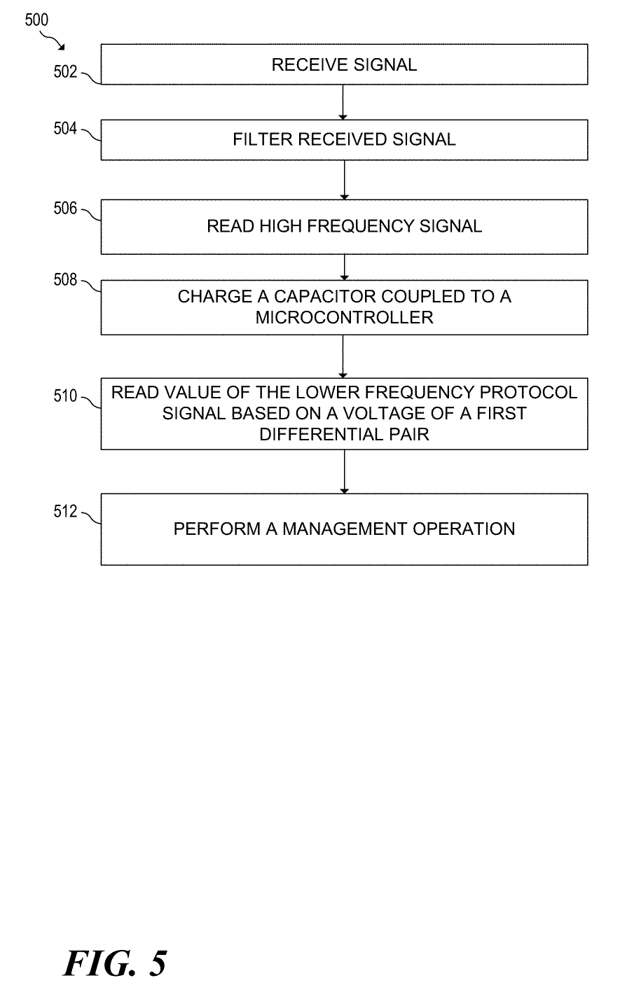

FIG. 5 is a flowchart of an example method for performing signal filtering. Method 500 may be described below as being executed or performed by a system, for example, system 100, 200, or 300. Other suitable systems and/or computing devices may be used as well. Method 500 may be implemented in the form of executable instructions stored on at least one machine-readable (e.g. a non-transitory) storage medium of the system and executed by at least one processor of the system (e.g. processor 105 or 302). Alternatively or in addition, method 500 may be implemented in the form of electronic circuitry (e.g., hardware). In alternate examples of the present disclosure, one or more blocks of method 500 may be executed substantially concurrently or in a different order than shown in FIG. 5. In alternate examples of the present disclosure, method 500 may include more or fewer blocks than are shown in FIG. 5. In some examples, one or more of the blocks of method 500 may, at certain times, be ongoing and/or may repeat.

Method 500 may start at block 502 at which point a processor, such as processor 302 may receive via a communication interface of a computing device (e.g. high frequency serial communication interface 108). At block 506, capacitors 316, 320 may filter the received signal into a high frequency protocol signal and a lower frequency serial protocol signal. At block 506, processor 340 may read a value of the high frequency serial protocol signal.

At block 508, processor 302 may charge a capacitor (e.g. capacitor 318) coupled to processor 302. In various examples, processor 302 may be coupled to a differential pair (e.g. differential pair 112) of high frequency serial communication interface 108. Processor 302 may determine a ground voltage value based on a voltage value of the differential pair.

At block 510, responsive to charging the capacitor, processor 302 may read the value of the lower frequency protocol signal based on the determined ground value. At block 512, responsive to reading the value of the lower frequency serial protocol signal, processor 302 may perform a management operation on the computing device.

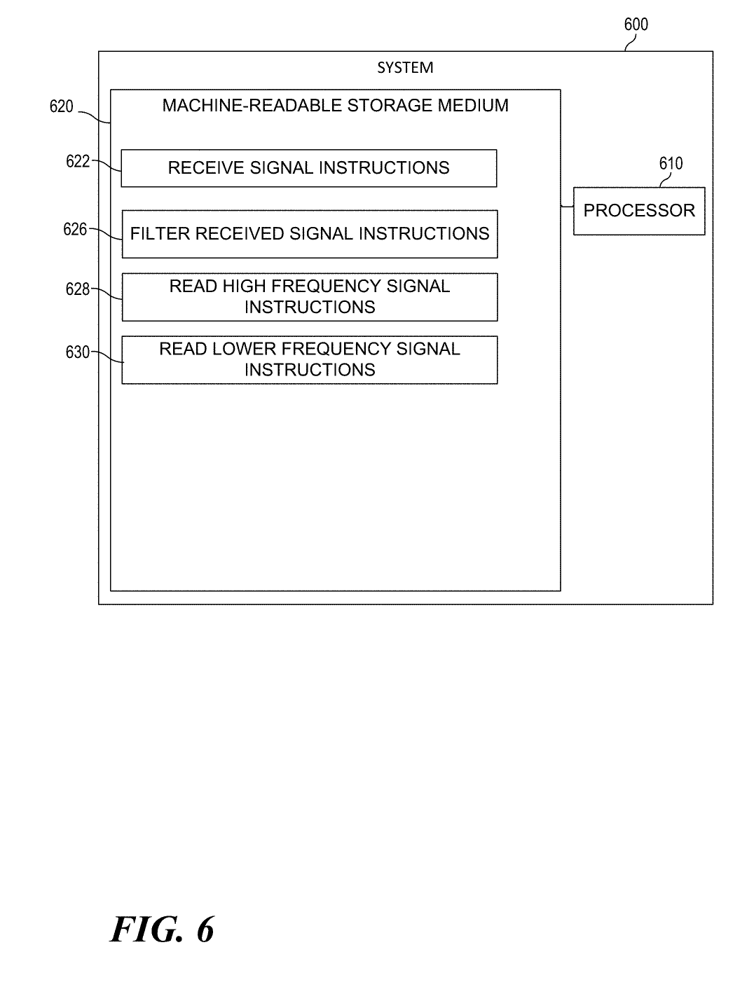

FIG. 6 is a block diagram of an example system for performing signal filtering. System 600 may be similar to system 100, 200, 300, for example. In the example of FIG. 6, system 600 includes a processor 610 and a machine-readable storage medium 620. Storage medium 620 is non-transitory in various examples. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 610 may be one or more central processing units (CPUs), microprocessors, and/or other hardware devices suitable for retrieval and execution of instructions stored in machine-readable storage medium 620. In the particular examples shown in FIG. 6, processor 610 may fetch, decode, and execute instructions 622, 624, 626, 628, 630 to perform signal filtering. As an alternative or in addition to retrieving and executing instructions, processor 610 may include one or more electronic circuits comprising a number of electronic components for performing the functionality of one or more of the instructions in machine-readable storage medium 620. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within system 600, as shown in FIG. 6. In this situation, the executable instructions may be “installed” on the system 600. Alternatively, machine-readable storage medium 620 may be a portable, external or remote storage medium, for example, that allows system 600 to download the instructions from the portable/external/remote storage medium. In this situation, the executable instructions may be part of an “installation package”. As described herein, machine-readable storage medium 620 may be encoded with executable instructions to perform signal filtering.

Referring to FIG. 6, receive signal instructions 622, when executed by a processor (e.g., 610), may cause processor 610 to receive, via a communication interface of the computing device, a signal comprising data encoded with a high frequency serial communication protocol and data encoded with a serial communication protocol that has a lower frequency than the high frequency serial communication protocol.

Filter received signal instructions 626, when executed, may cause processor 610 to filter, with a capacitor, the received signal into a high frequency protocol signal and a lower frequency serial protocol signal. Read high frequency signal instructions 628, when executed, may cause processor 610 to read a value of the high frequency signal. Read lower frequency signal instructions 630, when executed, may cause processor 610 to read a value the lower frequency protocol signal.

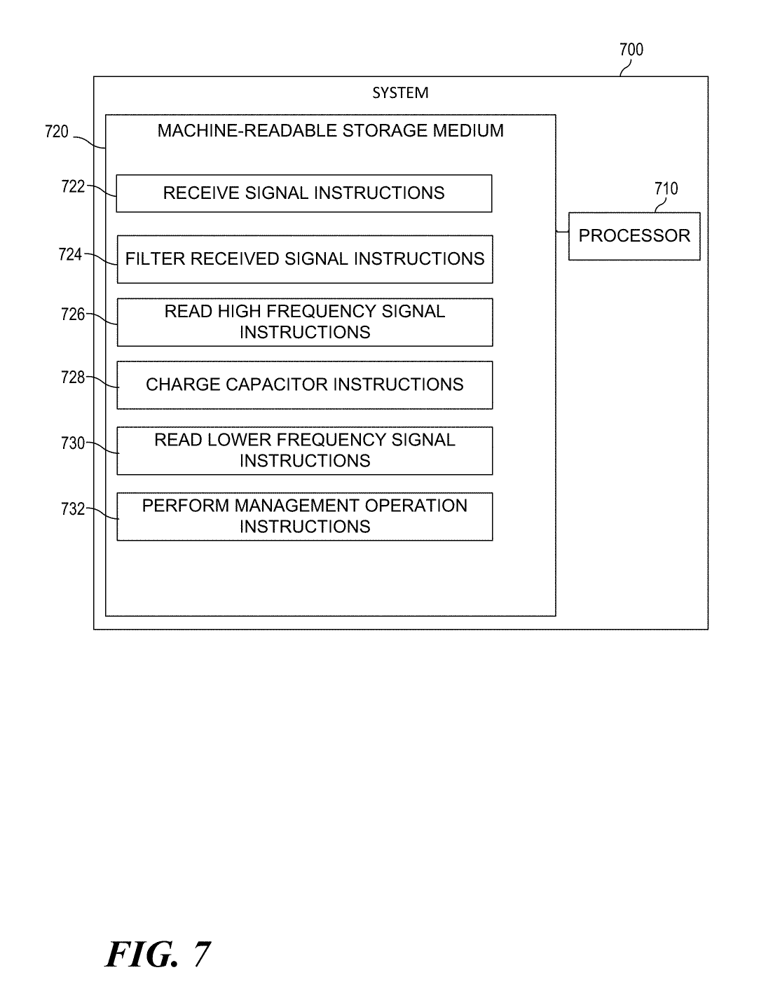

FIG. 7 is a block diagram of an example system for performing signal filtering. System 700 may be similar to system 100, 200, 300, for example. In the example of FIG. 7, system 700 includes a processor 710 and a machine-readable storage medium 720. Storage medium 720 is non-transitory in various examples. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 710 may be one or more central processing units (CPUs), microprocessors, and/or other hardware devices suitable for retrieval and execution of instructions stored in machine-readable storage medium 720. In the particular examples shown in FIG. 7, processor 710 may fetch, decode, and execute instructions 722, 724, 726, 728, 730, 732, to perform signal filtering. As an alternative or in addition to retrieving and executing instructions, processor 710 may include one or more electronic circuits comprising a number of electronic components for performing the functionality of one or more of the instructions in machine-readable storage medium 720. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 720 may be any electronic, magnetic, optical, or other physical storage device that stores executable instructions. Thus, machine-readable storage medium 720 may be, for example, Random Access Memory (RAM), an Electrically-Erasable Programmable Read-Only Memory (EEPROM), a storage drive, an optical disc, and the like. Machine-readable storage medium 720 may be disposed within system 700, as shown in FIG. 7. In this situation, the executable instructions may be “installed” on the system 700. Alternatively, machine-readable storage medium 720 may be a portable, external or remote storage medium, for example, that allows system 700 to download the instructions from the portable/external/remote storage medium. In this situation, the executable instructions may be part of an “installation package”. As described herein, machine-readable storage medium 720 may be encoded with executable instructions to perform signal filtering.

Referring to FIG. 7, receive signal instructions 722, when executed by a processor (e.g., 710), may cause processor 710 to receive, via a communication interface of the computing device, a signal comprising data encoded with a high frequency serial communication protocol and data encoded with a serial communication protocol that has a lower frequency than the high frequency serial communication protocol.

Filter received signal instructions 724, when executed, may cause processor 710 to filter, with a capacitor, the received signal into a high frequency protocol signal and a lower frequency serial protocol signal. In some examples, the high frequency communication protocol may comprise at least one of a Serial Attached SCSI (SAS) or a PCI Express (PCIe) protocol. In some examples the lower frequency communication protocol comprises an RS-232 protocol.

Read high frequency signal instructions 726, when executed, may cause processor 710 to read a value of the high frequency signal. Charge capacitor instructions 728 may cause processor 710 to charge a capacitor electrically coupled to the microcontroller.

Read lower frequency signal instructions 730, when executed, may cause processor 710 to read a value the lower frequency protocol signal. In some examples, to read the lower frequency serial protocol signal, processor 710 may determine a ground voltage value based on a voltage of a first differential pair of the communication interface, and read lower frequency cause the processor to read the value of the lower frequency protocol signal based on the determined ground value.

Responsive to reading the value of the lower frequency signal, perform management operation instructions 732, when executed, may cause processor 710 to perform a management operation on the computing device. To perform the management operation, processor 710 may perform at least one of: a firmware update of a component of the computing device, a power-up up the computing device, or a selection of a communications protocol for the communication interface, as some examples.

1. A non-transitory machine-readable storage medium encoded with instructions, the instructions that, when executed, cause a processor of a computing device to:
receive, via a communication interface of the computing device, a signal comprising data encoded with a high frequency serial communication protocol and data encoded with a serial communication protocol that has a lower frequency than the high frequency serial communication protocol,
filter, with a capacitor, the received signal into a high frequency protocol signal and a lower frequency serial protocol signal;
read a value of the high frequency signal; and
read a value the lower frequency protocol signal.

2. The non-transitory machine-readable storage medium of claim 1, further comprising instructions that, when executed, cause the processor to:
determine a ground voltage value based on a voltage of a first differential pair of the communication interface,
wherein the instructions that cause the processor to read the lower frequency protocol signal comprises instructions that cause the processor to read the value of the lower frequency protocol signal based on the determined ground value.

3. The non-transitory machine-readable storage medium of claim 1, instructions that cause the processor to read the value of the lower frequency protocol signal comprise instructions that, when executed, cause the processor to:
charge a capacitor electrically coupled to the microcontroller; and
read the value of the lower frequency protocol signal responsive to charging the capacitor coupled to the processor.

4. The non-transitory computer-readable storage medium of claim 1, wherein the high frequency communication protocol comprises at least one of a Serial Attached SCSI (SAS) or a PCI Express (PCIE) protocol, and
wherein the lower frequency communication protocol comprises an RS-232 protocol.

5. The non-transitory computer-readable storage medium of claim 1 comprising instructions that, when executed, cause the processor to:
responsive to reading the value of the lower frequency signal, perform a management operation on the computing device,
wherein the instructions that cause the processor to perform the management operation comprise instructions that, when executed, cause the processor to perform at least one of:
a firmware update of a component of the computing device,
a power-up up the computing device, or
a selection of a communications protocol for the communication interface.

6. A method comprising:
receiving, via a communication interface of a computing device, a signal comprising data encoded with a high frequency serial communication protocol and data encoded with a serial communication protocol that has a lower frequency than the high frequency serial communication protocol,
filtering, with a capacitor, the received signal into a high frequency protocol signal and a lower frequency serial protocol signal;
reading, with a first processor, a value of the high frequency signal;
reading, with a second processor, a value the lower frequency protocol signal; and
responsive to reading the value of the lower frequency signal, performing a management operation on the computing device.

7. The method of claim 6, wherein performing the management operation comprises performing at least one of:
performing a firmware update of a component of the computing device,
powering up the computing device,
selecting a communications protocol for the communication interface, or
resolving a conflict between a plurality of hosts of the communication interface.

8. The method of claim 6, wherein the high frequency communication protocol comprises at least one of a Serial Attached SCSI (SAS) or a PCI Express (PCIE) protocol.

9. The method of claim 6, wherein the received signal is filtered using an alternating current (AC) coupling capacitor.

10. The method of claim 6, comprising:
determining a ground voltage value based on a voltage of a first differential pair of the communication interface,
wherein reading the lower frequency protocol signal comprises reading values of the lower frequency protocol signal based on the determined ground value.

11. The method of claim 6, wherein the processor is coupled to at least one differential pair of the communication interface.

12. The method of claim 6, wherein reading the lower frequency protocol signal comprises:
charging a capacitor electrically coupled to the processor; and
reading the value of the lower frequency protocol signal responsive to charging the capacitor coupled to the processor.

13. The method of claim 6, wherein the lower frequency serial protocol comprises an RS-232 protocol.

14. A system comprising:
a computing device, the computing device comprising:
a transmitter coupled to a high frequency serial communication interface, the transmitter to transmit a signal to another computing device via the high frequency communication interface;
a processor coupled to the high frequency serial communication interface, the processor to:
generate a lower frequency protocol signal, a value of the lower frequency protocol signal to cause the another computing device to perform a management operation; and
transmit the lower frequency protocol signal on the high frequency serial communication interface;
a capacitor network to:
soften edges from the lower frequency protocol signal; and
add the softened lower frequency protocol signal to the high frequency protocol signal on the high frequency communication interface.

15. The system of claim 14, wherein the lower frequency protocol comprises an RS-232 protocol, and
wherein the higher frequency protocol comprises at least one of:
a Serial Attached SCSI (SAS) protocol or a PCI Express (PCIe) protocol.

16. The system of claim 14, the processor to:
determine a ground voltage value based on a voltage of a first differential pair of the high frequency serial communication interface.
wherein to generate the lower frequency protocol signal, the processor to: generate the value of the lower frequency protocol signal based on the determined ground value.

17. The system of claim 14,
wherein to cause the another computing device to perform the management operation comprises causing the another computing device to:
perform a firmware update of a component of the another computing device,
power up the another computing device,
select a communications protocol for the communication interface, or
resolve a conflict between a plurality of hosts of the communication interface.

18. The system of claim 14, the high frequency serial communication interface comprising a differential pair,
wherein the processor is coupled to the differential pair.

19. The system of claim 14, wherein the processor to receive a lower frequency serial protocol signal from the another computing device; and
read a value of the lower frequency protocol signal.

20. The system of claim 14, wherein to read the lower frequency serial protocol signal, the computing device to:
charge a capacitor; and
read the value of the lower frequency protocol signal responsive to charging the capacitor.
